(19) United States
(12) Patent Application Publication
(10) Pub. No.: US 2010/0086165 A1
(43) Pub. Date: Apr. 8, 2010

(54) Universal Earbud Adapter

(76) Inventor: Dwayne Wilson, Oak Creek, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/559,862

(22) Filed: Sep. 15, 2009

Related U.S. Application Data
(60) Provisional application No. 61/103,493, filed on Oct. 7, 2008.

(51) Int. Cl. H04R 25/00; B21D 31/00

(52) U.S. Cl. 381/374; 72/362; 381/380

(57) ABSTRACT

The invention discloses a universal earbud adapter apparatus comprised of a wire frame and coating, and including an earbud stem support loop, earbud cradle and earslide component.

### CROSS-REFERENCE TO RELATED APPLICATIONS

This application claims priority to U.S. Provisional Application No. 61/103493 filed on Oct. 7, 2008.

### FIELD OF INVENTION

This invention relates generally to the field of audio accessories and more specifically to a universal “earbud” adapter apparatus.

### BRIEF DESCRIPTION OF DRAWINGS

FIG. 1a is one embodiment of universal earbud adapter apparatus made from wire.

FIG. 1b illustrates a left and right universal earbud adapter apparatus, each made from wire.

FIG. 2 is an alternate embodiment of a universal earbud adapter apparatus with an outer coating.

FIG. 3 is an alternate embodiment of a universal earbud adapter apparatus with an optional flexible tension component.

FIG. 4 is a sectional view of a universal earbud adapter apparatus showing both the inner wire frame and the coating.

### BACKGROUND

Earbuds are earphones inserted into the ear canal. This type of audio earphones or speakers is commonly provided with MP3 players and other personal electronic audio devices. Accordingly, the earbud adapter market is equivalent to the market for MP3 devices and all competing audio devices as well as the combined market for numerous other personal electronic devices.

In the present art, earbuds typically consist of an ear-insert portion and a stem. The ear insert portion is typically inserted directly into the outer ear canal of the user, and held in place only by contact between the outer ear and the outer ear canal, without other structural support. The ear insert portion generally consists of a housing encasing a small speaker and further includes padding, configured for placement into the user's ear, which is mounted on the stem. The stem is generally a housing, which is cylindrical, tubular, oval or rectangular and encases wiring and other electrical components known in the art.

A cord typically connects the earbud adapter to an MP3 or other personal electronic device.

Earbuds can be unstable, the shape of the in-ear component is not always customized to a user's ear canal, and users must often adjust them to hold them in place and keep them from falling out. Thus, existing earbuds known in the art are structurally unstable devices, ill suited to hands-free use.

Audio earphones incorporating one or more speakers mounted to or behind a hard, flexible headband or ear are currently known in the art to allow users to listen to MP3 and personal electronic devices, and are considered more stable than earbuds, although they are more cumbersome, larger to store and may create an undesirable aesthetic appearance.

Also, known in the art are rigid hook shaped structures called ear clips. Ear clips have traditionally been fixably attached to an earbud and manufactured integrally with the earbud housing or stem housing. These rigid clips, however, are not adjustable for individual users, and are not removable to allow users to use them with their favorite brands and types of earbuds.

Although some selectively attachable ear clips are known in the art (e.g., on which commercially manufactured JBL Inc., located in Northridge Calif.) such separate assembly is primarily a manufacturing and packaging convenience. These detached ear clips are not adapted for use with multiple earbuds having a range of configurations, or for users having a range of ear sizes, and does not make the earbud adapters universal.

There has been some effort to provide a more comfortable, versatile and detachable ear clip. For example, WIPO international patent application 2007/095572 (Dean '572) discloses a device for securing an earbud adapter without actual insertion of the earbud into the ear. The device is formed from soft, pliable material, which fits in and around a user's ear with an ear clip. The device has a central opening, which is positioned adjacent to a user's ear canal when in place. This opening serves as a universal receiver for earbud heads and secures an earbud head by the tight fit of the opening. However, Dean '572 does not disclose an earbud adapter clip that has a bendable wire to comfortably fit the contours of a user's ear while also securing the earbud adapter to a user's ear by attaching to the stem of the earbud.

It is thus desirable to have a universal earbud adapter apparatus which can be adapted and separately purchased for all or most commercially available earbuds, and further configured to accommodate the ear size and physical contours of a user's face.

### Glossary

As used herein, the term “earbud” refers to small speakers that are inserted directly into the ear of a user.

As used herein, the term “earbud stem” refers to a portion of an earbud device that is elongated or cylindrical and completely or partially encases wire which is connected to an earbud.

As used herein, the term “earbud stem support loop” provides support for an earbud stem.

As used herein, the term, “deformable” or “deformable material” means any material which can be reshaped, deformed, molded or customized when pressure is applied to customize device from which it is made, without altering the functionality of the device.

As used herein, the term “earslide component” means a structural component adapted to slide behind the upper portion of a user's ear.

As used herein, the term “earbud cradle” means a structural component or contour which provides support to an earbud or component directly connected to an earbud and facilitates the positioning and stability of the earbud.

As used herein, the term “coating” includes rubber, silicon, rust proofing agents, fabric, felt, plastic, paint, waterproofing agents, powder coating, leather or any combination thereof, as well as any other material known in the art which may be used for coating wire.

As used herein, the term “wire return point” means a point at which a segment a wire is bent in a direction from another segment or portion of the wire to at least one form a contour, loop, or partial loop.

As used herein, the term “elastic tension component” means a component which is elasticized or deformable to more securely hold a universal earbud adapter apparatus in place around or around a user's ear.

As used herein, the term“clamp” may include but is not limited to a clip, a spring clip, a spring clip release mechanism or any other clipping or clamping mechanism known in the art adapted to enclose and secure earbud adapter stem.

### SUMMARY OF THE INVENTION

The invention disclosed herein is a universal earbud adapter apparatus designed to attach securely to most known earbuds and to offer a higher level of adaptability to the particular shape of a user's ear, which also improves the sound quality by positioning the earbud more securely to the user's ear canal.

### DETAILED DESCRIPTION OF EMBODIMENTS OF THE INVENTION

For the purpose of promoting an understanding of the present. invention, references are made in the text hereof to embodiments of a universal earbud adapter apparatus, only some of which are depicted in the figures. It should nevertheless be understood that no limitations on the scope of the invention are thereby intended. One of ordinary skill in the art will readily appreciate that modifications to the dimensions, size, and shape of the components may vary, and that alternate but functionally similar materials from which a universal earbud adapter apparatus is made can be used. This inclusion of additional elements will be deemed readily apparent and obvious to one of ordinary skill in the art, and that equivalent relationships to those illustrated in the drawings and described in the written description do not depart from the spirit and scope of the present invention. Some, but not all of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related. For example, one embodiment of the universal earbud adapter as disclosed herein may be of varying dimensions and materials while having the same function as features of the invention described herein.

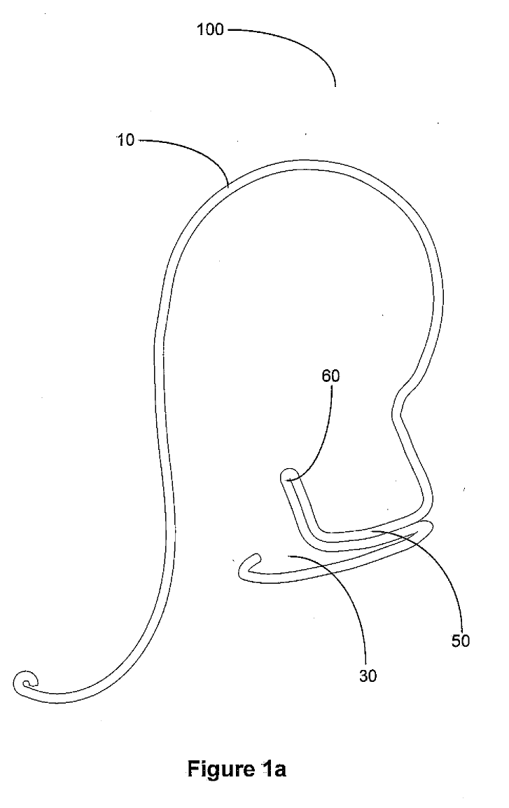

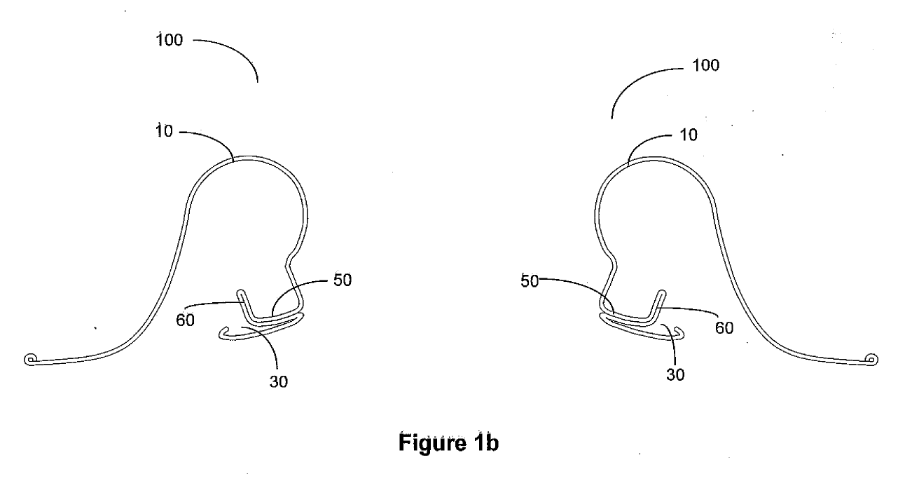

FIG. 1a shows an exemplary embodiment of a universal earbud adapter device in use with a conventional, commercially available earbud known in the art. In the embodiment shown, universal earbud adapter apparatus 100 is wire frame 10 which is bent, machined, stamped or molded to form earbud stem support loop 30 and earbud cradle 50. In the embodiment shown, wire frame 10 is bent at wire return point 60 to form earbud stem support loop 30 and earbud cradle 50. Wire frame 10 may be easily bent to form a secure grip around a user's ear, and to position the ear bud speaker more securely in the ear canal for better sound quality.

In the embodiment shown in FIG. 1a, wire frame 10 is comprised of 0.3 to 0.56 percent magnesium, 0.001 phosphorus to 0.10 percent phosphorus, 0.0001 to 0.92 percent sulpher, 0.01 to 0.3 percent silicon, 0.03 to 0.1 percent carbon and 0.02 copper to 0.10 percent copper. In other embodiments, wire frame 10 may be comprised of steel, aluminum, copper, plastic, brass, tungsten, rubber, fabric, resin, synthetic fabric, leather and combinations thereof. In the embodiment shown, wire frame 10 has a gauge on the American Wire Gauge (AWG) scale of (seventeen) 17 to (nineteen) 19 AWG, but may have gauges measured on other scales or be of gauges of ten to twenty AWG.

FIG. 1b illustrates a pair of universal earbud adapter devices, each of which is specifically adapted for use in a left or right ear.

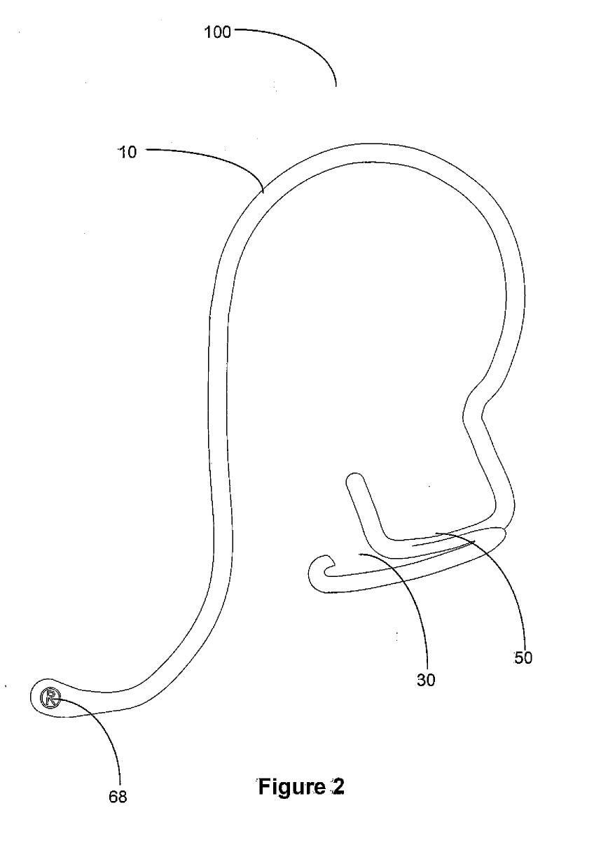

FIG. 2 illustrates a universal earbud adapter apparatus with an internal wire frame 10 (not visible) covered with a coating. In the embodiment shown the coating fully encases wire frame 10, but in other embodiments wire frame coating wire frame 10 may only be partially coated. The coating may be rubber, silicon, rust proofing agents, fabric, felt, plastic, paint, waterproofing agents, powder coating, leather or any combination thereof, as well as any other material known in the art which may be used for coating wire.

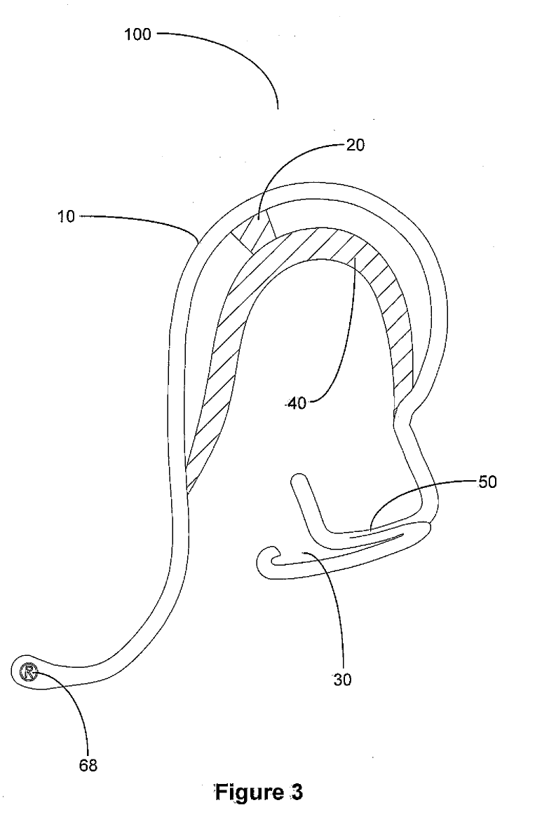

FIG. 3 illustrates an embodiment of universal earbud adapter apparatus 100 which further includes an optional tension support component 40. The elasticized tension support component helps hold universal earbud adapter in place against or around a user's ear, an may be of elastic or softened material for comfort. FIG. 3 further illustrates the used of stamped left/right designation 68 which is imprinted, raised or adhered anywhere on the apparatus to distinguish the right and left universal earbud adapter 100.

In other embodiments, universal earbud adapter apparatus may utilize an option spring clip (the spring clip release mechanism of which is behind earbud adapter stem and is not shown in this drawing). Other embodiments may include any clipping or clamping mechanism known in the art adapted to enclose and secure earbud adapter stem.

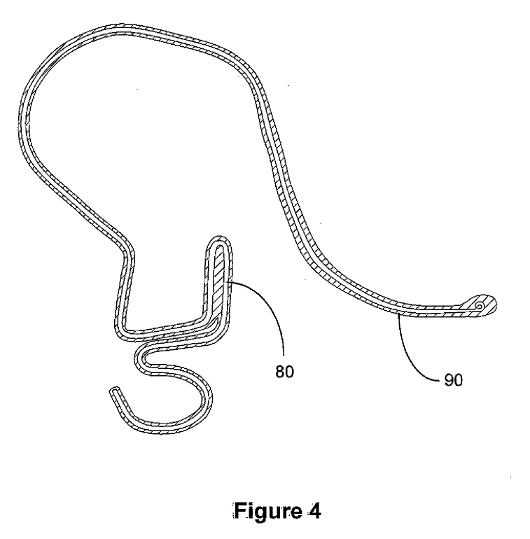

FIG. 4 is sectional view of universal earbud adapter apparatus 100 which illustrates deformable wire frame 80 and coating 90.

What is claimed is:

1. A universal earbud adapter apparatus comprised of:
an earbud cradle;
earslide component; and
an earbud stem support loop.

2. The apparatus of claim 1 wherein said earbud cradle, said earslide component, said earbud stem support loop are constructed from a single piece of wire.

3. The apparatus of claim 2 wherein said wire is comprised of 0.3 to 0.56 percent magnesium, 0.001 phosphorus to 0.10 percent phosphorus, 0.0001 to 0.92 percent sulpher, 0.01 to 0.3 percent silicon, 0.03 to 0.1 percent carbon and 0.02 copper to 0.10 percent copper.

4. The apparatus of claim 2 wherein said wire is comprised of a material selected from a group consisting of steel, aluminum, copper, plastic, brass, tungsten, rubber, fabric, resin, synthetic fabric, leather and combinations thereof.

5. The apparatus of claim 2 wherein said wire has a gauge on the America Wire Gauge (AWG) scale of 17 to 19.

6. The apparatus of claim 2 that further includes at least one coating.

7. The apparatus of claim 6 wherein said coating is selected from a group consisting of rubber, silicon, rust proofing agents, fabric, felt, plastic, paint, waterproofing agents, powder coating, leather or any combination thereof, as well as any other material known in the art which may be used for coating wire.

8. The apparatus of claim 2 wherein said wire is capable of withstanding a force of 230,000 to 300,000 pounds per square inch (PSI).

9. The apparatus of claim 1 wherein said apparatus is partially coated with rubber.

10. The apparatus of claim 1 wherein said apparatus is completely coated with rubber.

11. The apparatus of claim 1 wherein said apparatus further includes at least one wire return point.

12. The apparatus of claim 1 wherein said apparatus is made by machining.

13. The apparatus of claim 1 which includes a structural component for alleviating pressure against the skin.

14. The apparatus of claim 6 which further includes at least one elastic tension component.

15. The apparatus of claim 14 wherein said elastic tension component is selected from a group consisting of rubber, plastic, fabric, elastic, nylon, synthetic material, leather and wire.

16. The apparatus of claim 14 wherein said elastic tension component is connected to said coating at at least one connection point.

17. The apparatus of claim 14 wherein said elastic tension component is integrally molded or stamped from said coating.

18. The apparatus of claim 1 wherein said apparatus is made from an extruded material.

19. A method of making a universal earbud adapter having a wire frame consisting of the steps of:
bending said wire frame to form at least one ear contour;
bending said wire frame to create at least one ear slide component; and
bending said wire frame to create at least one earbud stem support loop.

20. The apparatus of claim 19 which further includes the step of creating at least one elastic tension component.

21. A universal earbud adapter apparatus comprised of:
an earbud cradle;
earslide component;
an earbud stem support loop; and
a clamp.
